(19) United States
(12) Patent Application Publication
(10) Pub. No.: US 2026/0244253 A1
(43) Pub. Date: Aug. 20, 2026

(54) DOCK AND POWER SUPPLY METHOD THEREOF

(71) Applicant: Wistron Corporation, New Taipei City (TW)

(72) Inventors: LU SHENG ZHOU, New Taipei City (TW); WEN BIN HONG, New Taipei City (TW); QIYUAN SU, New Taipei City (TW)

(21) Appl. No.: 19/188,153

(22) Filed: Apr. 24, 2025

(30) Foreign Application Priority Data
Feb. 20, 2025 (CN) 202510192536.6

(51) Int. Cl. G06F 1/26; G06F 1/16

(52) U.S. Cl. CPC G06F 1/26; G06F 1/1632

(57) ABSTRACT

A dock and a power supply method thereof are disclosed. The power supply method of the dock includes the following steps: detecting a voltage level of a general-purpose input/output (GPIO) pin through the dock; determining whether the voltage level is a first voltage level so as to generate a determination result; and switching to either a first power supply mode or a second power supply mode to provide power according to the determination result. The dock only needs to connect to the display and the device to be charged through two cables to meet general usage conditions, so it may greatly reduce the need for cables and make the daily work environment tidier and more efficient.

### CROSS-REFERENCE TO RELATED APPLICATION

This application claims priority to and the benefit of China Application Serial No. 202510192536.6, filed in the China National Intellectual Property Administration (CNIPA) on Feb. 20, 2025, the entire content of which is incorporated herein by reference as if fully set forth below in its entirety and for all applicable purposes.

### TECHNICAL FIELD

The present invention relates to a dock, more particularly, to a dock and a power supply method thereof.

### BACKGROUND

In general, a dock may be used as an expansion device and connect to a mobile device such as a notebook. With the development of technologies, the types and functions of the connection ports of a dock become more and more diverse, which increases the types of external cables that may be connected to a dock including power cables, video cables, data cables, network cables, mouse cables, keyboard cables, etc.

Although a dock disposed on an office desk may be connected to a display, notebook, keyboard and mouse respectively through different cables (such as a USB cable, keyboard cable, mouse cable and power cable), it also makes the entire office desk quite messy.

In addition, while the power consumption required by a system in most daily usage situations is relatively small, a conventional dock still needs an external adapter for power supply, which not only wastes electricity, but also increases the number of connection wires, resulting in the inability to improve the tidiness of the work environment. Therefore, the above-mentioned problems encountered in the prior art still need to be solved.

### SUMMARY

In view of this, a dock and a power supply method thereof are proposed in the present invention to effectively solve the above-mentioned problems in the prior art.

An embodiment of the present invention is a power supply method of a dock. In this embodiment, the power supply method includes the following steps: detecting the voltage level of a general-purpose input/output (GPIO) pin through the dock; determining whether the voltage level is a first voltage level so as to generate a determination result; and switching to either a first power supply mode or a second power supply mode to provide power according to the determination result.

An embodiment of the present invention is a dock. In this embodiment, the dock includes a first switch, a second switch, a first control circuit, and a second control circuit. The second switch is electrically connected to the first switch. The first control circuit is electrically connected to a control terminal of the first switch. The second control circuit is electrically connected to a control terminal of the second switch. In a first power supply mode, the first control circuit turns off the first switch and the second control circuit turns on the second switch. In a second power supply mode, the first control circuit turns on the first switch and the second control circuit turns off the second switch.

Compared with prior art, the dock and the power supply method thereof proposed in the present invention may meet the working needs of a dock and charge the notebook under normal use conditions with only two universal serial bus Type-C (USBC) cables, thereby greatly reducing the demand for cables, making the work environment tidier and more efficient. Only in special cases where higher charging power is required, an external adapter is needed to provide greater power.

To further understand the features and technical contents of the present invention, please refer to the following detailed description and drawings of the present invention. However, the drawings provided are only for reference and description and are not intended to limit the present invention.

### BRIEF DESCRIPTION OF THE DRAWINGS

FIG. 1 illustrates a flowchart of a power supply method of a dock in an embodiment of the present invention.

FIG. 2 illustrates a flowchart showing that step S18 of FIG. 1 further includes steps S20 to S28.

FIG. 3 illustrates a functional block diagram of a dock in an embodiment of the present invention.

FIG. 4A illustrates a schematic diagram showing that the system power of the dock receives power from the adapter to charge the notebook in adapter power supply mode.

FIG. 4B illustrates a schematic diagram showing that the system power supply of the dock receives power from the display to charge the notebook in display power supply mode.

FIG. 5 illustrates a functional block diagram of a dock in another embodiment of the present invention.

FIG. 6 illustrates a schematic diagram showing that a dock only needs two USB-C cables to connect to a display and a notebook respectively to meet general work needs in an embodiment of the present invention.

### DETAILED DESCRIPTION

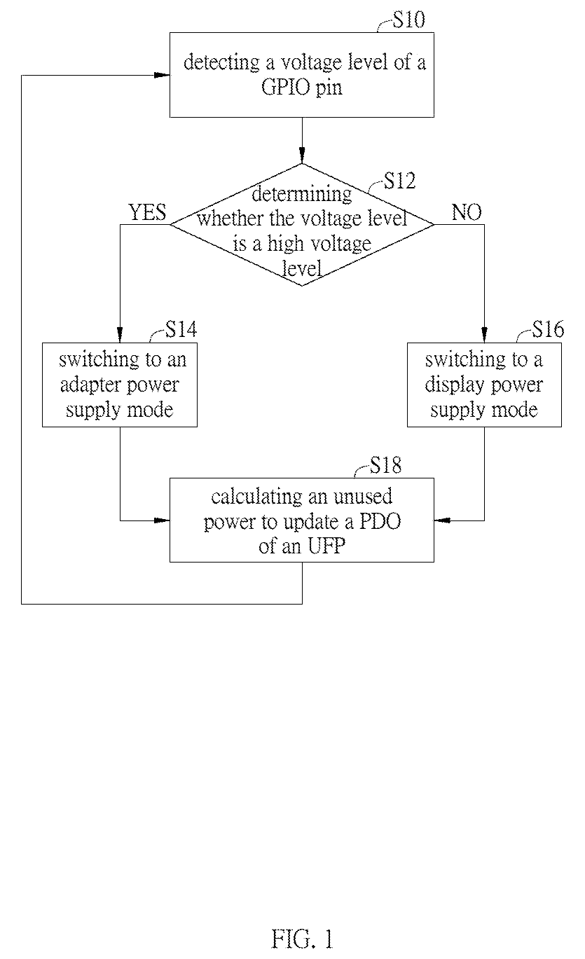

The following describes the implementation methods disclosed in the present invention through specific embodiments in conjunction with FIG. 1 to FIG. 6. Those skilled in the art may understand the advantages and effects of the present invention from the contents disclosed in this specification. However, the following disclosure is not intended to limit the protection scope of the present invention.

The structures shown in the drawings of the present invention are not drawn according to the shapes and dimensions of the actual implementation. For example, the sizes of certain elements are exaggerated for convenience of explanation.

Further, it will be understood that when an element is referred to as being “connected to” another element, it may be directly coupled to the other element or indirectly coupled to the other element, or intervening elements may be present. As used herein, "electrical connection" may refer to a physical and/or non-physical electrical connection, or may be a wired and/or wireless electrical connection.

All terms (including technical and scientific terms) used herein have the same meaning as commonly understood by one of ordinary skill in the art to which the present invention belongs. It will be further understood that terms, such as those defined in commonly used dictionaries, should be interpreted as having a meaning consistent with their meaning in the context of the relevant art and the present invention, and will not be interpreted in an idealized or overly formal sense.

In addition, it should be understood that although the terms "first", "second", "third", etc. may be used herein to describe various elements, components and/or sections, these elements, components and/or sections should not be limited by these terms. These terms are only used to distinguish one element, component or section from another element, component or section. Thus, a "first element," "component" or "portion" discussed below could be termed a second element, component or portion without departing from the teachings herein.

An embodiment of the present invention is a power supply method for a dock. In this embodiment, the power supply method of the dock is used to switch to different power supply modes under different usage requirements/situations to provide power to the dock with different external power supplies, and during the entire power switching process, the dock may obtain power without power failure.

Please refer to FIG. 1. FIG. 1 illustrates a flowchart of a power supply method of a dock in this embodiment. As shown in FIG. 1, the power supply method of the dock includes the following steps:

step S10: detecting the voltage level of a general-purpose input/output (GPIO) pin;

step S12: determining whether the voltage level detected in the step S10 is a high voltage level to generate a determination result;

step S14: if the determination result of the step S12 is YES, meaning that the voltage level of the GPIO pin is a high voltage level, then switching to an adapter power supply mode;

step S16: if the determination result of the step S12 is NO, meaning that the voltage level of the GPIO pin is a low voltage level, then switching to a display power supply mode; and

step S18: calculating the unused power to update the power data object (PDO) of an upstream facing port (UFP).

For example, a microcontroller unit (MCU) may detect the voltage level of the GPIO pin and determine whether the voltage level of the GPIO pin is a high voltage level or a low voltage level. When the MCU determines that the voltage level of the GPIO pin is a high voltage level, it means that a higher-charging power condition is required at this time, so the MCU will switch the power supply mode of the dock to an adapter power supply mode with a larger power supply (such as a 19.5V power supply). In the adapter power supply mode, the dock is electrically connected to an adapter to receive power from the adapter. When the MCU determines that the voltage level of the GPIO pin is a low voltage level, it means that only a general-charging power condition is required at this time, so the MCU will switch the power supply mode of the dock to a display power supply mode with a smaller power supply (such as a 17V power supply). In the display power supply mode, the dock is electrically connected to a display to receive power from the display.

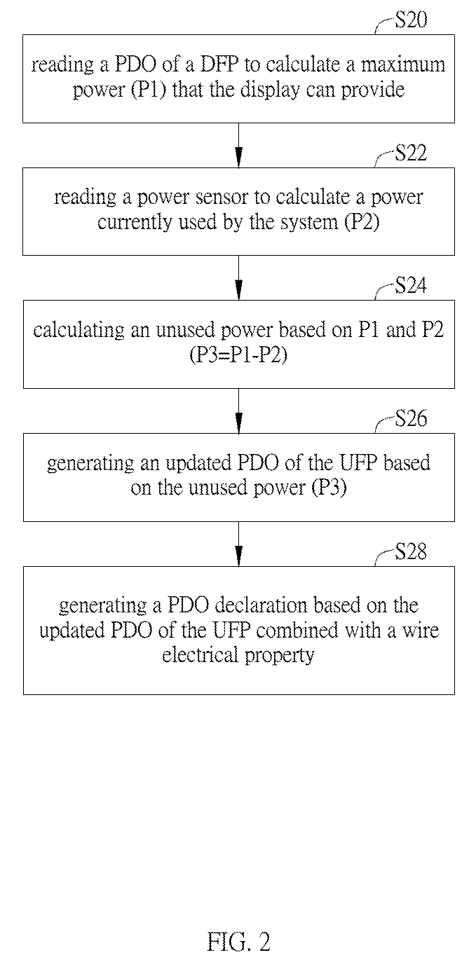

Please refer to FIG. 2. In practical applications, the step S18 of FIG. 1 may include the following steps:

step S20: reading a PDO supported by a downstream facing port (DFP) to calculate a maximum power (P1) that the display may provide;

step S22: reading a power sensor to calculate a power currently used by the system (P2);

step S24: calculating the unused power (P3=P1-P2) based on the maximum power (P1) that the display may provide and the power currently used by the system (P2);

step S26: generating an updated PDO of the upstream facing port (UFP) based on the unused power (P3); and

step S28: generating a PDO declaration based on the updated PDO of the UFP combined with the wire electrical property.

In the step S24, the maximum power (P1) that may be provided by the display is subtracted from the power currently used by the system (P2) to obtain the unused power (P3). Thus, in the display power supply mode, the dock that receives power from the display may adopt a dynamic power-charging method (such as the above steps S20 to S28) to charge the device to be charged (such as a notebook), but not limited thereto.

Another embodiment of the present invention is a dock. In this embodiment, the dock may be switched to different power supply modes under different usage requirements/situations and different external power sources may be used to provide power to the dock, and during the entire power switching process, the dock may continue to obtain power without power failure.

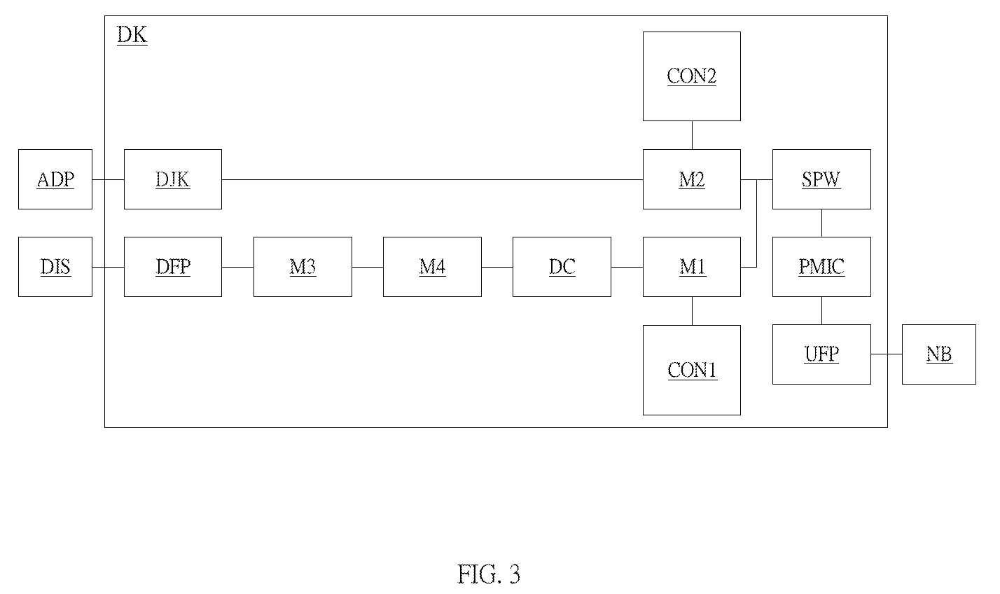

Please refer to FIG. 3. FIG. 3 illustrates a functional block diagram of a dock DK in this embodiment. As shown in FIG. 3, the dock DK includes a direct current jack DJK, a downstream facing port DFP, a system power supply SPW, a first metal-oxide-semiconductor field-effect transistor (MOS) M1, a second MOS M2, a DC-DC converter DC, a third MOS M3, a fourth MOS M4, a first control circuit CON1, a second control circuit CON2, a power management integrated circuit PMIC and an upstream facing port UFP. The second MOS M2 is electrically connected to the first MOS M1. The system power supply SPW is electrically connected to the first MOS M1 and the second MOS M2. The direct current jack DJK is used to selectively connect to an adapter ADP. The downstream facing port DFP is used to connect to an upstream facing port (not shown) of a display DIS. The system power supply SPW is connected to a device to be charged (such as a notebook NB) through the power management integrated circuit PMIC. That is to say, the power management integrated circuit PMIC is connected to the notebook NB through the upstream facing port UFP of the dock DK, and then converts the power provided by the system power supply SPW into the power for charging the notebook NB.

The third MOS M3 and the fourth MOS M4 are connected in series between the downstream facing port DFP and the DC-DC converter DC. The first MOS M1 is electrically connected between the DC-DC converter DC and the system power supply SPW. The second MOS M2 is electrically connected between the direct current jack DJK and the system power supply SPW. The first control circuit CON1 is electrically connected to a control terminal of the first MOS M1. The first control circuit CON1 determines to turn off or turn on the first MOS M1 according to a first voltage transmitted to the first MOS M1 and a second voltage transmitted to the second MOS M2. The second control circuit CON2 is connected to a control terminal of the second MOS M2. The second control circuit CON2 determines to turn off or turn on the second MOS M2 according to a first voltage transmitted to the first MOS M1 and a second voltage transmitted to the second MOS M2.

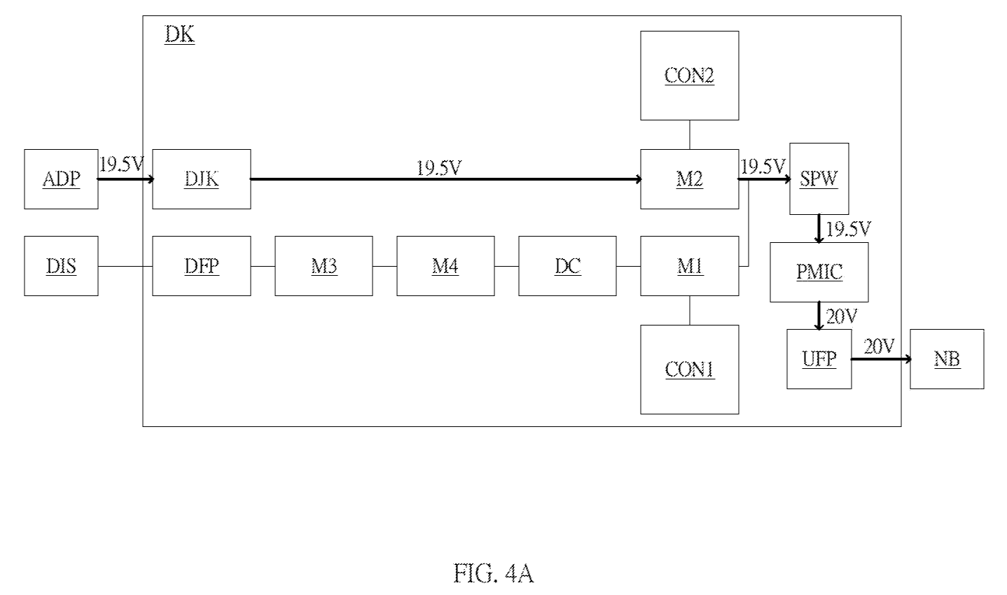

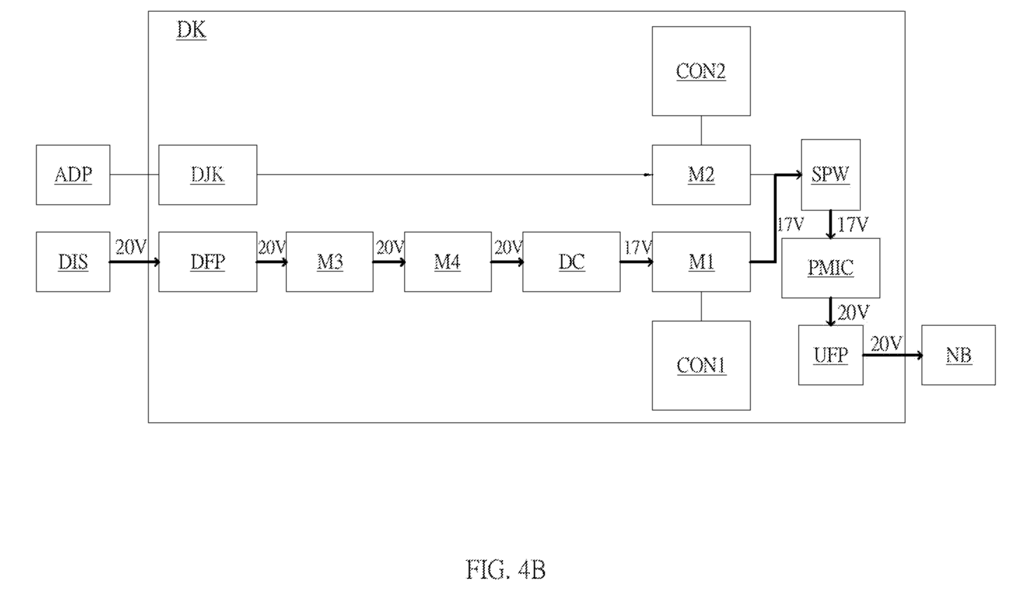

Please refer to FIG. 4A. When the MCU determines that the voltage level of the GPIO pin is a high voltage level and switches the power supply mode of the dock DK to the first power supply mode (the adapter power supply mode), the first control circuit CON1 turns off the first MOS M1 in the adapter power supply mode and the second control circuit CON2 turns on the second MOS M2 in the adapter power supply mode. The direct current jack DJK of the dock DK is connected to the adapter ADP, and the power supply (19.5V) received by the adapter ADP may be transmitted to the system power supply SPW through the turned-on second MOS M2, and then used to charge the notebook NB through the power management integrated circuit PMIC.

Please refer to FIG. 4B. When the MCU determines that the voltage level of the GPIO pin is a low voltage level and switches the power supply mode of the dock DK to the second power supply mode (the display power supply mode), the first control circuit CON1 turns on the first MOS M1 in the display power supply mode and the second control circuit CON2 turns off the second MOS M2 in the display power supply mode. It is further understood that the first MOS M1 and the second MOS M2 are not turned on or turned off at the same time. When the downstream facing port DFP of the dock DK is connected to the upstream facing port (UFP) of the display DIS, they communicate with each other to confirm that the upstream facing port (UFP) of the display DIS serves as source and the downstream facing port DFP of the dock DK serves as receiver (sink). The downstream facing port DFP of the dock DK receives the power supply (20V) of the display DIS and transmits the power to the DC-DC converter DC through the turned-on third MOS M3 and fourth MOS M4 in sequence. After the power supply is converted into a 17V power supply by the DC-DC converter DC, it is transmitted to the system power supply SPW through the turned-on first MOS M1, and then used to charge the notebook NB through the power management integrated circuit PMIC. It should be noted that the third MOS M3 and the fourth MOS M4 may be turned on or turned off at the same time, and the power supplies of 19.5V, 20V and 17V mentioned above are only embodiments and the present invention is not limited thereto.

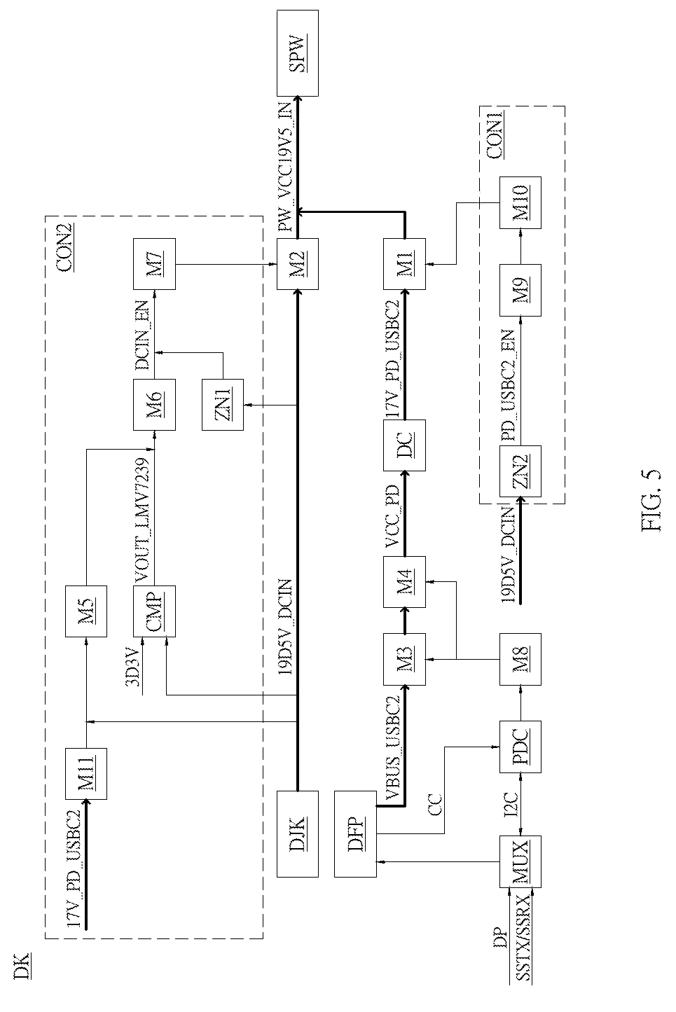

Please refer to FIG. 5. FIG. 5 illustrates a functional block diagram of a dock DK in another embodiment of the present invention. As shown in FIG. 5, the dock DK includes a direct current jack DJK, a downstream facing port DFP, a system power supply SPW, a third MOS M3, a fourth MOS M4, a DC-DC converter DC, a first MOS M1, a second MOS M2, a first control circuit CON1, a second control circuit CON2, an eighth MOS M8, a multiplexer MUX and a power delivery controller PDC.

The first control circuit CON1 includes a second Zener diode ZN2, a ninth MOS M9 and a tenth MOS M10. The second control circuit CON2 includes a comparator CMP, a first Zener diode ZN1, a fifth MOS M5, a sixth MOS M6, a seventh MOS M7 and an eleventh MOS M11.

The downstream facing port DFP is connected to the third MOS M3, the multiplexer MUX and the power delivery controller PDC respectively. The multiplexer MUX is connected to the downstream facing port DFP and the power delivery controller PDC respectively. The power delivery controller PDC is connected to the downstream facing port DFP1, the multiplexer MUX and the eighth MOS M8 respectively. The eighth MOS M8 is connected to the power delivery controller PDC, the third MOS M3 and the fourth MOS M4 respectively. The third MOS M3 is connected between the downstream facing port DFP and the fourth MOS M4. The fourth MOS M4 is connected between the third MOS M3 and the DC-DC converter DC. The DC-DC converter DC is connected between the fourth MOS M4 and the first MOS M1. The first MOS M1 is connected between the DC-DC converter DC and the system power supply SPW. An output terminal of the second Zener diode ZN2 is connected to the ninth MOS M9. The ninth MOS M9 is connected between the second Zener diode ZN2 and the tenth MOS M10. The tenth MOS M10 is connected between the ninth MOS M9 and the first MOS M1.

The direct current jack DJK is connected to the second MOS M2. The second MOS M2 is connected between the direct current jack DJK and the system power supply SPW. An input terminal of the comparator CMP is connected between the direct current jack DJK and the second MOS M2 and an output terminal of the comparator CMP is connected to the sixth MOS M6. The eleventh MOS M11 is connected to the fifth MOS M5. The fifth MOS M5 is connected between the eleventh MOS M11 and the sixth MOS M6. The sixth MOS M6 is connected between the output terminal of the comparator CMP and the seventh MOS M7. An input terminal of the first Zener diode ZN1 is connected between the direct current jack DJK and the second MOS M2. An output terminal of the first Zener diode ZN1 is connected between the sixth MOS M6 and the seventh MOS M7. The seventh MOS M7 is electrically connected between the sixth MOS M6 and the second MOS M2.

In practical applications, the third MOS M3, the fourth MOS M4, the first MOS M1 and the second MOS M2 are P-type metal-oxide-semiconductor field-effect transistors (MOSFETs), and the fifth MOS M5, the sixth MOS M6, the seventh MOS M7, the eighth MOS M8, the ninth MOS M9, the tenth MOS M10 and the eleventh MOS M11 are N-type MOSFETs, but the present invention is not limited thereto.

Next, practical applications of the dock DK of the present invention will be described in detail through the following different working modes.

(1) The first working mode: the downstream facing port DFP of the dock DK is connected to the display and the direct current jack DJK of the dock DK is not connected to the adapter.

When the downstream facing port DFP of the dock DK is connected to the upstream facing port (UFP) of the display, the UFP of the display will first provide the power of, for example, 5V/3A to the downstream facing port DFP of the dock DK. At this time, the voltage VBUS_USBC2 transmitted from the downstream facing port DFP to the third MOS M3 is, for example, 5V.

When the power delivery controller PDC works normally, the downstream facing port DFP of the dock DK and the UFP of the display communicate with each other to confirm that the UFP of the display serves as source and the downstream facing port DFP of the dock DK serves as receiver (sink). When the downstream facing port DFP of the dock DK reads that the power data object (PDO) supported by the UFP of the display is, for example, 20V/5A, the downstream facing port DFP of the dock DK will request the UFP of the display to supply 20V/5A to the downstream facing port DFP of the dock DK. At this time, the voltage VBUS_USBC2 transmitted from the downstream facing port DFP to the third MOS M3 will increase from the original 5V to 20V.

The power delivery controller PDC controls the turning on of the eighth MOS M8, the third MOS M3 and the fourth MOS M4 so that the voltage VCC_PD transmitted by the fourth MOS M4 to the DC-DC converter DC is 20V. After the conversion by the DC-DC converter DC, the voltage 17V_PD_USBC2 outputted by the DC-DC converter DC to the first MOS M1 and the tenth MOS M10 becomes 17V.

Since the direct current jack DJK of the dock DK is not connected to the adapter and may not be powered by the adapter, the voltage 19D5V_DCIN outputted by the direct current jack DJK to the second MOS M2 is 0V.

The first Zener diode ZN1 receives the 0V voltage 19D5V_DCIN, making the voltage DCIN_EN outputted by the first Zener diode ZN1 to the seventh MOS M7 also 0V, and the gate-source voltage (VGS) of the seventh MOS M70V and turned off. The VGS of the second MOS M2 is 0V and turned off. The second Zener diode ZN2 receives the voltage 19D5V_DCIN of 0V, making the voltage PD_USBC2_EN outputted by the second Zener diode ZN2 to the ninth MOS M9 also 0V, and the VGS of the ninth MOS M90V and turned off.

The tenth MOS M10 and the first MOS M1 are turned on by the 17V voltage 17V_PD_USBC2, making the voltage PW_VCC19V5_IN outputted by the first MOS M1 to the system power supply SPW t17V, so as to charge the device to be charged (such as a notebook).

Therefore, in the first working mode, the power supply mode of the dock DK is switched to the display power supply mode and the display power supply is converted into 17V system power supply SPW for the dock DK.

(2) The second working mode: the direct current jack DJK of the dock DK is connected to the adapter and the downstream facing port DFP of the dock DK is connected to the display.

When the direct current jack DJK of the dock DK is connected to the adapter and receives power from the adapter, the voltage 19D5V_DCIN outputted by the direct current jack DJK to the second MOS M2 is 19.5V. The second Zener diode ZN2 receives the voltage 19D5V_DCIN of 19.5V, making the voltage PD_USBC2_EN outputted by the second Zener diode ZN2 to the ninth MOS M9 5.6V, and the VGS of the ninth MOS M9 5.6V and turned on. The tenth MOS M10 and the first MOS M1 have VGS of 0V and are turned off.

The first Zener diode ZN1 receives the voltage 19D5V_DCIN of 19.5V, making the voltage DCIN_EN outputted by the first Zener diode ZN1 to the seventh MOS M73V, and the VGS of the seventh MOS M73V and turned on. The second MOS M2 is turned on because its VGS is -11V, making the voltage PW_VCC19V5_IN outputted by the second MOS M2 to the system power supply SPW 19.5V. At this time, the system power supply SPW of the dock DK is provided by the adapter with 19.5V.

When the downstream facing port DFP of the dock DK is connected to the display, since the voltage 19D5V_DCIN outputted by the direct current jack DJK remains at 19.5V, the voltage VOUT_LMV7239 outputted by the comparator CMP based on the comparison result between the voltage 19D5V_DCIN and the reference voltage 3D3V also remains at 0V, making the VGS of the sixth MOS M60V and turned off. The tenth MOS M10 and the first MOS M1 remain turned off. The second MOS M2 remains turned on, making the voltage PW_VCC19V5_IN outputted by the second MOS M2 to the system power supply SPW remain unchanged at 19.5V. At this time, the system power supply SPW of the dock DK is still maintained at 19.5V provided by the adapter.

Therefore, in the second working mode, the power supply mode of the dock DK is switched to the adapter power supply mode and the adapter supplies 19.5V of power to the system power supply SPW of the dock DK.

(3) The third working mode: the downstream facing port DFP of the dock DK is first connected to the display, and then the direct current jack DJK of the dock DK is connected to the adapter.

When the downstream facing port DFP of the dock DK is connected to the UFP of the display, the direct current jack DJK of the dock DK has not yet been connected to the adapter. At this time, the power supply mode of the dock DK is switched to the display power supply mode and the power supply provided by the display is converted to 17V to the system power supply SPW of the dock DK, which is the same as the first working mode.

When the direct current jack DJK of the dock DK is connected to the adapter and receives power from the adapter, the voltage 19D5V_DCIN outputted by the direct current jack DJK is 19.5V, and the voltage VOUT_LMV7239 outputted by the comparator CMP according to the comparison result between the voltage 19D5V_DCIN and the reference voltage 3D3V is 0V. As a result, the VGS of the sixth MOS M6 is 0V and turned off. The voltage PD_USBC2_EN outputted by the second Zener diode ZN2 to the MOS M9 is 5.6V, making the ninth MOS M9 turn on with VGS=5.6V. The tenth MOS M10 and the first MOS M1 have VGS of 0V and turned off.

The voltage DCIN_EN outputted by the first Zener diode ZN1 to the seventh MOS M7 is 3V, making the VGS of the seventh MOS M73V and turned on. The second MOS M2 is turned on because its VGS is -11V, making the voltage PW_VCC19V5_IN outputted by the second MOS M2 to the system power supply SPW 19.5V. At this time, the power supply mode of the dock DK is switched to the adapter power supply mode and the adapter provides 19.5V to the system power supply SPW of the dock DK.

Therefore, in the third working mode, the power supply mode of the dock DK will first switch to the display power supply mode and the display power supply will be converted to 17V and provided to the system power supply SPW of the dock DK; when the direct current jack DJK of the dock DK is connected to the adapter, the power supply mode of the dock DK will switch to the adapter power supply mode and the adapter will supply 19.5V to the system power supply SPW of the dock DK. Thereby, it may be ensured that the system power supply SPW of the dock DK may be continuously powered without power failure during the entire power switching process.

(4) The fourth working mode: the direct current jack DJK of the dock DK is first connected to the adapter, then the downstream facing port DFP of the dock DK is connected to the display, and finally the adapter is removed.

When the direct current jack DJK of the dock DK is connected to the adapter, and then the downstream facing port DFP of the dock DK is connected to the display, this is the same as the second working mode. The power supply mode of the dock DK is switched to the adapter power supply mode and the adapter supplies 19.5V to the system power supply SPW of the dock DK.

Next, when the adapter is removed, the direct current jack DJK of the dock DK is no longer connected to the adapter, making the voltage 19D5V_DCIN outputted by the direct current jack DJK start to drop from 19.5V. When the voltage 19D5V_DCIN drops to 17V, the voltage VOUT_LMV7239 outputted by the comparator CMP according to the comparison result between the voltage 19D5V_DCIN and the reference voltage 3D3V changes from 0V to 3.3V, making the VGS of the sixth MOS M6 3.3V and turned on. The voltage DCIN_EN outputted by the first Zener diode ZN1 to the seventh MOS M7 is 0V, making the VGS of the seventh MOS M70V and turned off. The VGS of the second MOS M2 is 0V and turned off.

When the voltage 19D5V_DCIN continues to drop to 5.6V, the voltage PD_USBC2_EN outputted by the second Zener diode ZN2 to the ninth MOS M9 is 0V, making the VGS of the ninth MOS M90V and turned off. The tenth MOS M10 and the first MOS M1 are turned on by the 17V voltage 17V_PD_USBC2 outputted by the DC-DC converter DC, making the voltage PW_VCC19V5_IN outputted by the first MOS M1 to the system power supply SPW 17V, thereby charging the notebook through the power management integrated circuit PMIC. At this time, the power supply mode of the dock DK is switched to the display power supply mode and the display power supply is converted to 17V and provided to the system power supply SPW of the dock DK.

Therefore, in the fourth working mode, the power supply mode of the dock DK will first switch to the adapter power supply mode, and the adapter will supply 19.5V to the system power supply SPW of the dock DK; when the adapter is removed, the direct current jack DJK of the dock DK is no longer connected to the adapter, and the power supply mode of the dock DK will switch to the display power supply mode and the display power supply will be converted to 17V and provided to the system power supply SPW of the dock DK. Thereby, it may be ensured that the system power supply SPW of the dock DK may be continuously powered without power failure during the entire power switching process.

According to the above-mentioned first to fourth working modes of the dock DK, it may be known that: when the direct current jack DJK of the dock DK is not connected to the adapter, the power supply mode of the dock DK may be switched to the display power supply mode and the display power supply is converted to 17V and provided to the system power supply SPW of the dock DK. Once the direct current jack DJK of the dock DK is connected to the adapter, the power supply mode of the dock DK is immediately switched to the adapter power supply mode and the adapter supplies 19.5V to the system power supply SPW of the dock DK. During the entire power switching process, the system power supply SPW of the dock DK may continuously obtain power without being powered off, thereby ensuring that the system power supply SPW of the dock DK may continuously charge the notebook without being powered off.

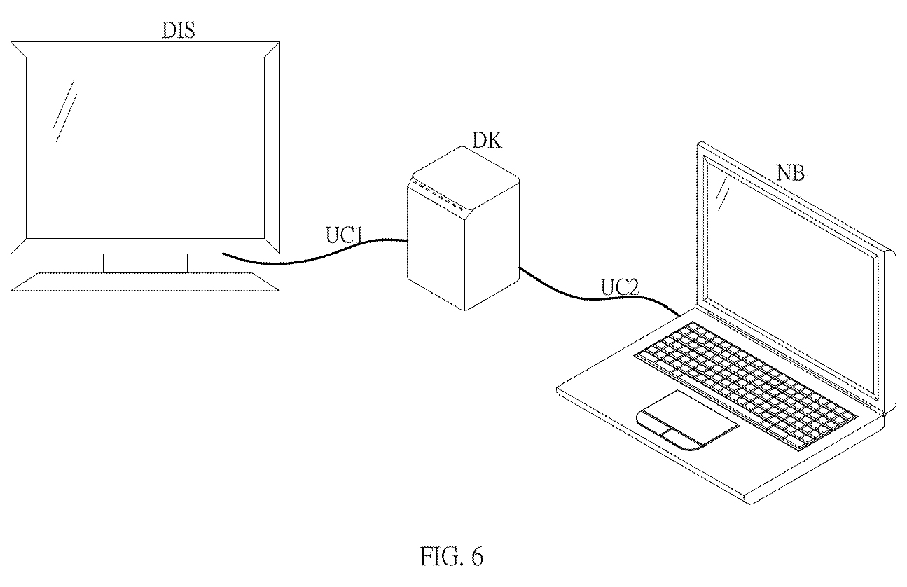

From the above, it may be seen that in most usage scenarios, as shown in FIG. 6, the dock DK proposed in an embodiment of the present invention only needs to be connected to the display DIS and the notebook NB through two USBC cables UC1 and UC2 respectively to meet the working needs of the dock DK and charge the notebook NB, thereby greatly reducing the demand for wires, making the daily work environment tidier and more efficient. Only when higher charging power is required in a special condition, the dock DK needs to be connected to an additional adapter to provide greater power.

The contents disclosed above are merely feasible embodiments of the present invention, and are not intended to limit the scope of the claims of the present invention. Therefore, all equivalent technical changes made based on the specification and the drawings of the present invention fall within the scope of the claims of the present invention.

What is claimed is:

1. A power supply method of a dock, comprising:
detecting a voltage level of a general-purpose input/output (GPIO) pin through the dock;
determining whether the voltage level is a first voltage level to generate a determination result; and
switching to one of a first power supply mode and a second power supply mode to provide power according to the determination result.

2. The power supply method according to claim 1, further comprising:
providing power in the first power supply mode in response to the voltage level being the first voltage level, wherein the first power supply mode is an adapter power supply mode.

3. The power supply method according to claim 2, further comprising:
electrically connecting the dock to an adapter to receive power from the adapter in the adapter power supply mode.

4. The power supply method according to claim 1, further comprising:
providing power in the second power supply mode in response to the voltage level being a second voltage level, wherein the second power supply mode is a display power supply mode.

5. The power supply method according to claim 4, further comprising:
electrically connecting the dock to a display to receive power from the display in the display power supply mode.

6. The power supply method according to claim 1, further comprising:
calculating an unused power to update a power data object (PDO) of an upstream facing port.

7. The power supply method according to claim 6, further comprising:
reading a downstream facing port to calculate a maximum power that is provided by a display;
reading a current system power usage;
calculating the unused power based on the maximum power that is provided by the display and the current system power usage; and
generating an updated PDO of the upstream facing port based on the unused power.

8. The power supply method according to claim 7, further comprising:
generating a PDO declaration based on the updated PDO of the upstream facing port combined with a wire electrical property.

9. A dock, comprising:
a first switch;
a second switch, electrically connected to the first switch;
a first control circuit, electrically connected to a control terminal of the first switch; and
a second control circuit, electrically connected to a control terminal of the second switch,
wherein in a first power supply mode, the first control circuit turns off the first switch and the second control circuit turns on the second switch,
wherein in a second power supply mode, the first control circuit turns on the first switch and the second control circuit turns off the second switch.

10. The dock according to claim 9, wherein the first power supply mode is an adapter power supply mode, in the adapter power supply mode, a direct current jack is electrically connected to an adapter to receive power from the adapter and transmits the power to a system power supply through the second switch which is turned on.

11. The dock according to claim 9, further comprising:
a system power supply, electrically connected to the first switch and the second switch;
a direct current jack, electrically connected to the second switch, for selectively electrically connecting to an adapter;
a downstream facing port, for electrically connecting to a display;
a third switch, electrically connected to the downstream facing port;
a fourth switch, electrically connected to the third switch; and
a DC-DC converter, electrically connected between the first switch and the fourth switch,
wherein the second power supply mode is a display power supply mode, in the display power supply mode, the downstream facing port is electrically connected to an upstream facing port of the display to receive power from the display and transmit the power to the system power supply through the third switch, the fourth switch, the DC-DC converter, and the first switch which are turned-on in sequence.

12. The dock according to claim 11, wherein the downstream facing port and the upstream facing port communicate with each other to confirm that the upstream facing port serves as source and the downstream facing port serves as receiver.

13. The dock according to claim 9, wherein the first control circuit determines whether to turn on or turn off the first switch according to a first voltage transmitted to the first switch and a second voltage transmitted to the second switch.

14. The dock according to claim 9, wherein the second control circuit determines whether to turn on or turn off the second switch according to a first voltage transmitted to the first switch and a second voltage transmitted to the second switch.

15. The dock according to claim 11, wherein in response to the downstream facing port being electrically connected to the display and the direct current jack not being electrically connected to the adapter, the system power supply provides power in the second power supply mode.

16. The dock according to claim 11, wherein in response to the direct current jack being electrically connected to the adapter and the downstream facing port being electrically connected to the display, the system power supply provides power in the first power supply mode.

17. The dock according to claim 11, wherein in response to the downstream facing port being electrically connected to the display first, the system power supply first provides power in the second power supply mode, and then in response to the direct current jack being electrically connected to the adapter, the system power supply is switched to provide power in the first power supply mode.

18. The dock according to claim 11, wherein in response to the direct current jack being electrically connected to the adapter first and the downstream facing port being electrically connected to the display, the system power supply first provides power in the first power supply mode, and then in response to the adapter being removed, the system power supply is switched to provide power in the second power supply mode.

19. The dock according to claim 11, wherein the first switch and the second switch are not turned on or turned off at the same time.

20. The dock according to claim 11, wherein the first switch, the second switch, the third switch and the fourth switch are all metal-oxide-semiconductor field-effect transistors (MOSFETs).
